(19) United States
(12) Patent Application Publication
(10) Pub. No.: US 2009/0119972 A1
(43) Pub. Date: May 14, 2009

(54) DESIGN FISHING HOOK FOR BAIT AND LURE

(76) Inventor: Hugh MacDonald Reilly, Queensland (AU)

Correspondence Address: HUGH Macdonald REILLY, 7 MAGRA COURT, EAGLEBY, Q 4207, omitted

(21) Appl. No.: 11/816,894

(22) PCT Filed: Feb. 22, 2006
(86) PCT No.: PCT/AU06/00224

§ 371 Date: Aug. 22, 2007

(30) Foreign Application Priority Data
Feb. 23, 2005 (AU) 2005900828

(51) Int. Cl. A01K 83/00

(52) U.S. Cl. 43/44.81; 43/43.16; 43/44.82

(57) ABSTRACT

A fishing hook device changing fundamentals of “J” shape fishing hooks with modifications to the extended shank length only allowing all prior art. Towing eye position relative to hook bend and hook point is changed allowing fish unrestricted access to the forward bait fish head clear of obstruction by the fishing line. Sharpened hook point faces away from the fisherman and cannot snag. This device has a once-only structural shape change only after the hook point impales flesh inside the fish mouth lower jaw. A second version has a re-settable structural shape change after the hook point impales the fish.

This patent reveals a new novel design fish hook device. Original innovation is disclosed as modification to and extension of the length of the shank only of the traditional “J” shaped fishing hook allowing use of all prior art without change. Shank length may be increased by two or three times the length of industry standard long-shank hooks with all other elements of the eye and the bend and sharpened hook point and barb retaining industry size ratios of fishing hooks and formed into a nominal “Z” shape or “S” shape. Refer FIG. 2. Drawing 1/5.

The “Z” shape changes fish hook fundamentals to present a bait fish, head first, clear of the fishing line, allowing an attack fish an unobstructed bite as it attempts to eat the bait fish in it's natural manner—“head” first. Refer FIG. 1. Drawing 1/5.

This presentation mode changes the basic shape of the hook from the traditional “J” shape hook. Once the point of the two dimensional “Z” shape hook penetrates flesh in the fish mouth and tension force is created in the fishing line, is this “Z” shape changes structural shape into a “J” shape. The “J” shape allows the fisherman to reel in his fish as always. Refer FIG. 3. Drawing 2/5.

The new design overcomes the two fundamental flaws in the existing “J” shape prior art fishing hooks used without basic change for thousands of years.

The first “J” shape hook flaw is that the taut fishing line is a solid physical obstruction the fish hits as it swims forward in attempt to eat naturally—head first. All marine and land creatures eat smaller creatures HEAD first as nature designed. Surprise and the faster closing speed of a head attack instantly disables the victim. A fish may then be swallowed whole head first—“alive”.

FIG. 6. shows a “J” shape fishing hook FIG. 4. used with a lead weight FIG. 5. as the fisherman pulls on the fishing line. The top lip of the attacking fish hits this unseen thin clear fishing line tending to bend it out of it's forward path. The bait fish on the flawed “J” shape fish hook is forced out of the way preventing a clean bite of the food the attacking fish is trying to eat. Refer FIG. 6 Drawing 3/5.

The second “J” shape flaw is caused by the sharp hook point pointing back towards the fisherman—it digs into anything it touches as the fishing line is pulled.

“J” shape fishing hook design has been retained unaltered because the fishermen cannot see the “fish-eating situation” as it occurs underwater. The myth is that a fish must be “hooked” by the quick reaction and skill of the fisherman. The “J” shape hook point moves rapidly towards the fisherman when he jerks the fishing line, Fishermen more often pull “J” hooks from the fish mouth to try to impale it. This myth has been revealed as a false perception by regular long-line fishing using “circle” hooks left for days deep in the oceans. Long-line fishermen come back to these thousands of unattended baited hooks days later, and haul in the catch of thousands of large fish. Fish cannot dislodge circle hooks from their jaw hinge as they try to swim away.

### BRIEF DESCRIPTION OF DRAWINGS

FIG. 1. Shows a fishing scene with the fisherman in his boat a distance away from his underwater baited “Z” shape fish hook. The bait-fish added to his hook disguises this hook as “food”. The attacking fish is given a clear bite of the head of this bait-fish clear of an obstructing fishing line.

The new shape of the fishing hook is shown to overcome the fundamental flaw of all prior art “J” shape fish hooks shown in FIG. 6.

FIG. 2. Shows the new style “Z” shape fishing hook without bait or fishing line.

FIG. 3. Shows the new “Z” shape fish hook immediately after it impaled the fish shown in FIG. 1. as the “Z” shape hook changed it's shape to a “J” shape under the tension force exerted by the fish pulling against the fishing line. Stretching tensile forces act to bend the weak nominal forty-five degree angle apex and to straighten out the two shank arms to become one long straight shank.

FIG. 4. Shows three variations of all “J” shape prior art fishing hooks.

FIG. 5. Shows prior art “J” shape fishing hook adapted as a current fishing jig by adding a lead ball near the towing “eye” and attached fishing line.

FIG. 6. Illustrates the fundamental flaw of all prior art fishing hooks. This contrasts with the same fishing scene illustrated in FIG. 1. FIG. 6. shows the prior art fishing hook adapted as a weighted Jig FIG. 5., with a bait-fish added to disguise the hook and appear as “food”. The fishing line when taut becomes an unseen physical barrier—an obstruction. This fishing line prevents this fish eating “food” in its' natural instinctive manner—“head” first. The fish hits the fishing line and is prevented from swallowing this bait fish in one mouthful by this fishing line which moves its' food away from its' mouth. The flaw cannot be corrected as the bait-fish is never added “tail first” and “head last” as it would be pulled backwards. No fish is fooled by a bait-fish swimming backwards. The bait-fish to appear “alive” must appear to swim forward.

FIG. 7. Shows the “Z” shape fish hook used in FIG. 1. With a bait-fish added showing the flattened, weakened nominal forty-five degree apex angle which bends under stretching tension force exerted between sharpened hook point and the opposite end towing eye tied to the fishing line.

FIG. 8. Shows the FIG. 7. “Z” hook without the bait-fish front elevation.

FIG. 9. Shows the FIG. 7. “Z” hook without the bait-fish side elevation.

FIG. 10. Shows the FIG. 7. “Z” hook without the bait-fish partly side elevation.

FIG. 11. Shows the FIG. 7. “Z” hook with a the bait-fish front elevation as the attacking fish views the bait-fish head to head ready to swallow whole

FIG. 12. Shows the FIG. 7. “Z” hook in the bait-fish in the water towed forward.

FIG. 13, FIG. 14., FIG. 15., FIG. 16., FIG. 17. and FIG. 18., show six variations of the new invention “Z” shape fish hook with FIG. 19. showing the bait-fish size in normal proportion to these hooks.

FIG. 20. Shows how a lead weight may be molded concentric around part of the bend of a “Z” shape hook as a possible balance weight to assist this hook to ride vertical in use.

FIG. 21. Shows a floatation “V” shape may be folded and added adjacent to the “eye” as a possible addition to the “Z” shape hook by extending a wire backwards from the normal eye of a “Z” shape hook.

FIG. 22. Shows one method of a weakened apex of the nominal forty-five degree angle in the extended shank may be formed by flattening that angle.

FIG. 23. Shows the “Z” shape hook manufactured in two arm sections joined as a pivot by a bolt and nut. Several alternate axles to this pivot angle joint are shown as alternatives. A small locking arm may be added to fix the angle and allow adjustment and reuse as a re-settable angle pivot as an alternative re-useable version.

FIG. 24. Shows an alternate shape of hook which may be used to present a bait-fish head clear of fishing line obstruction with the hook point facing away from the fisherman.

FIG. 25 and FIG. 26. Show two multiple hook versions which may provide a hook device without fishing line obstruction and have the fishing hook points facing away from the fisherman.

FIG. 27. Shows the “Z” hook formed with a small loop circle included in the nominal forty-five degree angle apex as an alternative.

FIG. 28. Shows the “Z” hook formed with a small loop circle external to the nominal forty-five degree angle apex as an alternative.

### DETAILED DESCRIPTION OF THE INVENTION DESIGN

There are three facts fishermen are vaguely aware of, but they appear not to draw from these facts, the correct conclusions. Fishermen know these facts but fail to give them weight. This patent is founded on these three facts.
The most important fact is that fish mostly eat fish as their daily food and these fish are “alive” at the time.
The second fact is that fish have incredible speed and rapid very fast acceleration, from just moving, to full speed, in almost an instant.
The third fact is that fish mostly eat live fish, “head first”.

This patent “Z” shape hook is designed to exploit these three facts, to catch more fish, by positioning the hook point right at the centre of that fish-eating drama, to target the most vulnerable spot in a fish mouth avoiding hard bone.

These fundamental facts apply in Nature more or less to all marine creatures.

This invention is limited to the common view of “fishing”, as one fisherman using one fishing line attached mostly to one baited fishing hook attempting to catch one fish at a time. Then he repeats the action until several fish are caught by that fisherman. No commercial methods like nets are applicable.

The evidence of fish eating “head” first when eating “live fish” is self-evident.

Fish daily eat fish alive. The head is eaten first in one continuous swallow. The head of the smaller fish goes down the throat of the attacking fish. The living head of the small fish goes down first and the tail goes down last. The evidence for this fact is easily observed by simply watching marine mammals like penguins and sea lions in their natural environment or when being fed at zoos and aquariums. They all eat a fish “head” first. They would be spiked otherwise by the dorsal and anal fins which open up if taken tail first. All fins fold down as the fish moves forward as part of its' natural streamlining.

This is self-evident when considered. The body of most fish species are designed to move forward. Most fish do not swim backward except to maneuver. The fins protrude outwards and the dorsal fin protrudes upward and slightly backward. These fins and gills fold down against the body as it moves through a passage head first. These fins and gills and scales and dorsal fins in a frightened fish being swallowed backwards, tail first, would expand like an umbrella pulled handle forward. Each dorsal fin would spike and lodge and choke any attack fish. The evidence of their own body design reveals that all fish eat their prey head first as their basic instinct. All land mammals also eat head first when swallowing live prey. Disable the brain in the head and then eat the prey body at leisure. This is noticed when fish are caught and fed to captive fish. No matter which way the fish is tossed the larger fish maneuvers their head to catch it head first. There are a few photos which are taken to show the greed of some fish taking one fish after another and photos to show how wide a fish can open its' mouth. These just caught fish generally have one fish tail exposed in the mouth and then the bait fish and the fish hook or lure which caught it. This is after-the-event evidence photos of the natural instinctive method used by fish to eat their food.

As each fish is equipped to move at lightning fast speed and to sense a rush of water movement created by another fish then each can move rapidly to avoid a fish trying to eat it. Any side attack, or attack from the rear creates water movement and fish knowledge of the attack and view of imminent attack.

Only a frontal attack avoids this water movement. Only a frontal head to head attack presents the least time to use knowledge of imminent attack. Only a frontal attack has the least body view and a frontal attack reduces and compresses the time of the attack as the closing speed is increased by the speed the victim is swimming forward. Fish design to swim forward prevents a victim moving into reverse direction. It can move to side or up or down only after brain assessment of danger in each direction. Too late, as reaction time to move that powerful tail to avoid the predator fish is insufficient. Surprise and speed allow fish to eat and keep on swimming as the live food goes down.

The fisherman knows very little of this fish-eating drama. He has his view of the fish world from above the water. He cannot see below the water normally. Even in clear shallow water vision is distorted by water movement and ripples. Moving images, pictures and television pictures form by a series of still frame pictures viewed as several frames per second to match the human visual range. The human eye cannot “see” the fish-eating action, movement too fast and mostly too far away. The fisherman therefore forms his own perception of these events to match the normal speed he sees fish swimming lazily around in the shallows.

Each attack encounter is individual and unique. Such generalizations as top and bottom used here are simplified representative descriptions only.

Elements of this invention are relative to the way fish swim and therefore relative to the vertical swim attitude in which most species eat their food. This vertical attitude places the attack fish mouth in a near constant position relative to the horizontal surface of the water they swim in. The roof of the inside mouth is mostly bone to protect the brain located above and this is mostly uppermost when swimming and when eating. This allows the inside of the mouth in the lower jaw to be targeted. This lower moveable jaw is lightly structured on a bone nominal half oval or semi-circle held mostly horizontal. The moveable jaw provides a muscle and flesh floor to target. This area has not previously been specifically targeted by prior art fishing hooks. “J” shape hooks have always depended on penetration in the mouth of the fish by chance that the hook point faced out of the mouth at the moment that the fisherman pulled the fishing line. If the hook point faced upwards the chances of catching a fish are reduced by at least fifty percent. If the “J” shape hook lay sideways as the bend supporting the hook point turns and is flattened horizontal as the attack fish mouth closes then there is a good chance the hook point may impale into either side of the fish mouth. It is only by random chance that a “J” shape hook will impale the softer muscle and flesh behind the semi-oval jawbone of the attack fish mouth. This softer area is vulnerable to a sharp hook point. The hook point penetrates this softer muscle which is prevented from squashing and moving away by the hard bone outer structure of this moveable jaw-line. A “Z” shape sharpened hook point specifically targets the muscle and flesh of this vulnerable lower jaw.

The “J” shape fishing hooks used today are founded on the same design used for thousands of years by fishermen. Men first used fish hooks fashioned from the materials available, bone and natural hook points on some thorn bushes. These fish hooks were crudely tied to the long fiber strings formed by nature in some trees and tree bark and vines tied together. When metal was discovered fish hooks were then made of metal. Metal technology evolved fish hooks to the very thin steel wire hooks of today. Modern hooks are very strong and Very thin resisting bending to the point of brittleness which snap if the shape is altered. The hook point is needle pointed and extremely sharp.

The basic shape of the modern fish hook follows the hook shape used thousands of years ago as a “J” shape with a tight small captive circle “eye” at one end and the other end sharpened to a needle point with a nominal semi-circle bend near the hook point causing this hook point to face the fisherman more or less as he pulls the fishing line tied to the hook eye. The fisherman pulls the fishing line and if the hook point is in the fish mouth it impales the fish and the fisherman has “hooked” the point into the inside of the fish mouth and hauls it back to him by the fishing line.

The myth that fish have to be “hooked” has current fishing hooks all designed the same basic “J” shape—a small circle eye at the shank end and a sharpened point at the other end of the semi-circle bend. The “J” shape design is so fishermen can “hook”. The sharp point moves towards the fisherman when he pulls on the fishing line tied to the “eye”.

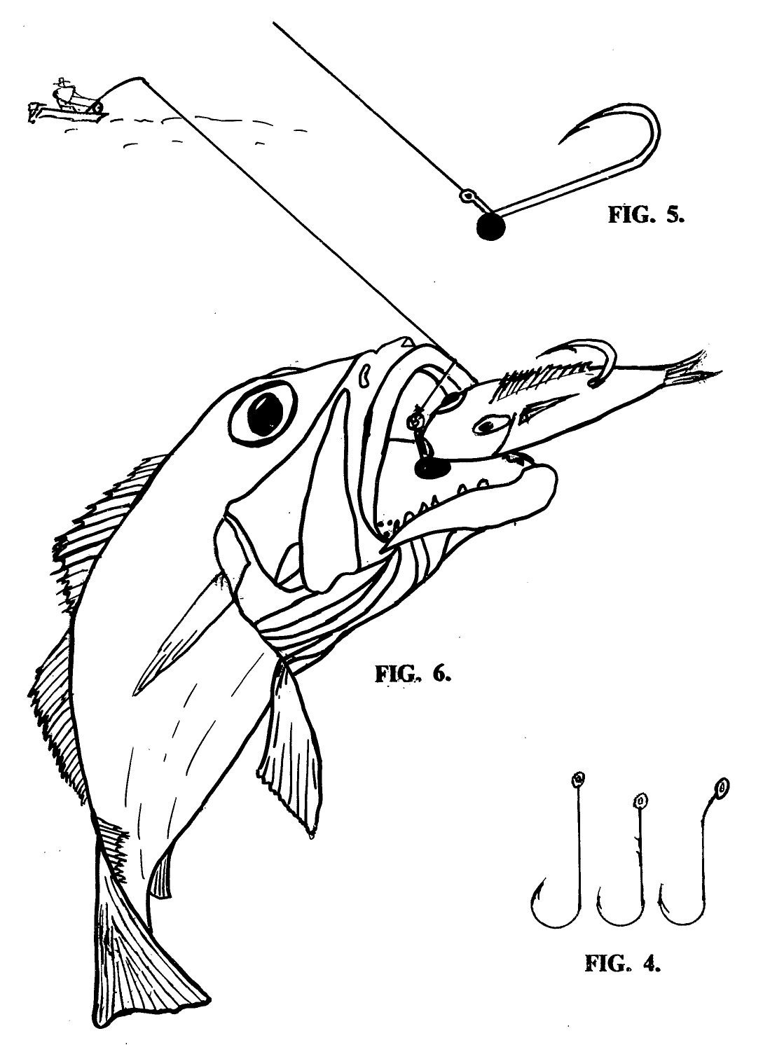

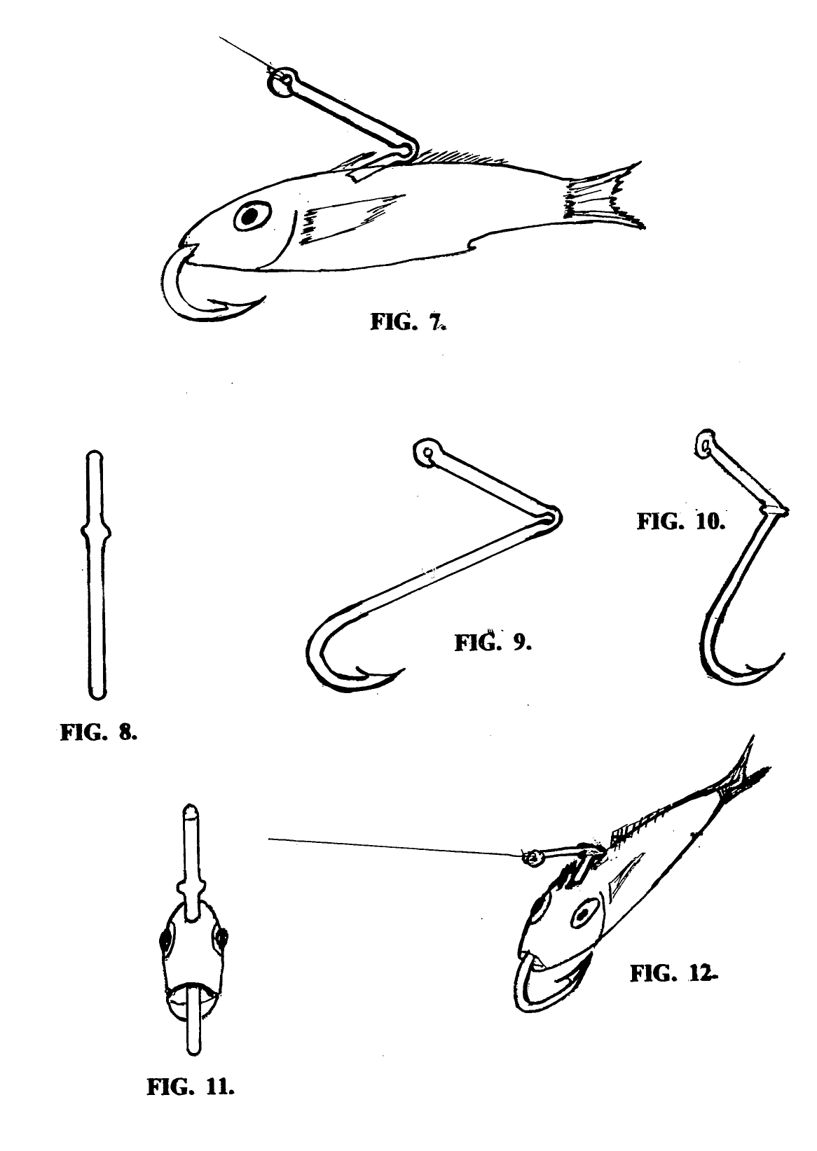

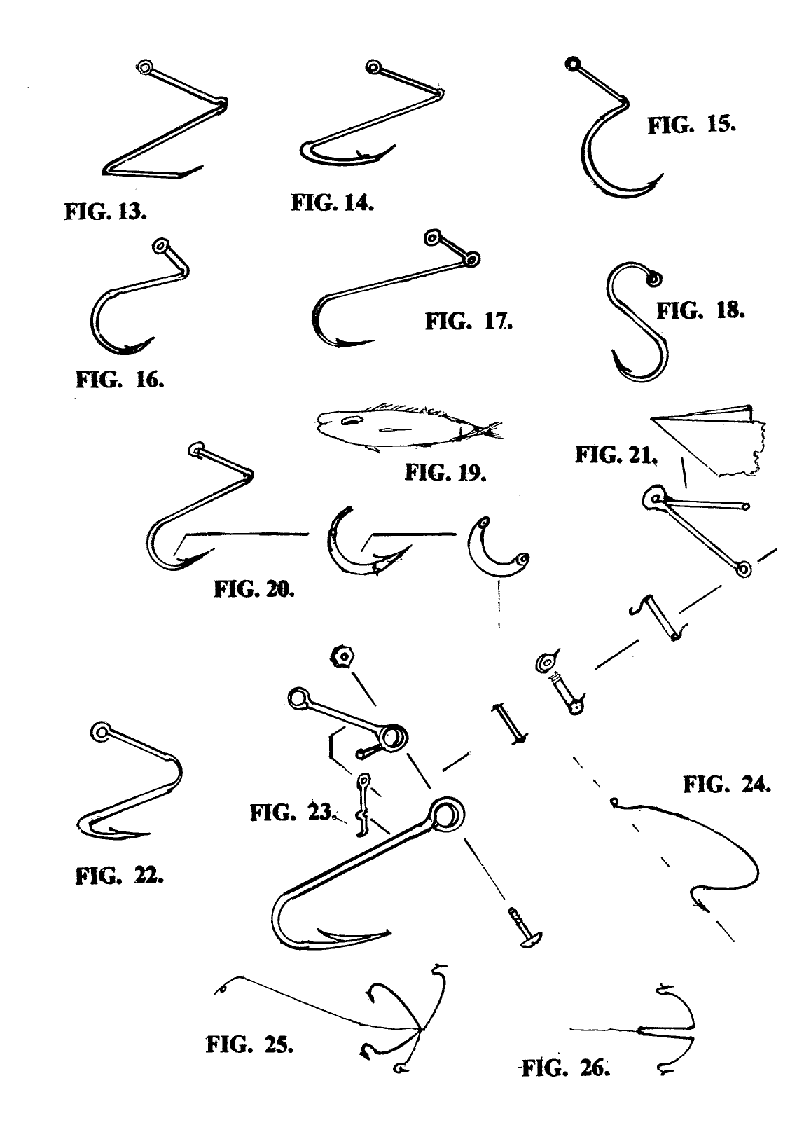

FIG. 6. reveals the fish hits the fishing line and has to either push this foreign obstruction out of the way to eat or spit it out. The taut fishing line prevents eating the clean swallow-in-one bite food. Fish mostly eat “head first” by instinct; eat the head to instantly disable the fish, and then swallow the body. Prior art fishing hooks have limitations created by the towing eye directly pulling the hook point towards the fisherman with, the hook point supporting bend, following last.

The new fishing hook design revealed in this patent overcomes this fundamental flaw of the “J” shape hook used unchanged for thousands of years. This “J” shape is excellent for hauling the fish back to the fisherman, but it is flawed because the hook point always points towards the fisherman making a natural presentation of the bait impossible.

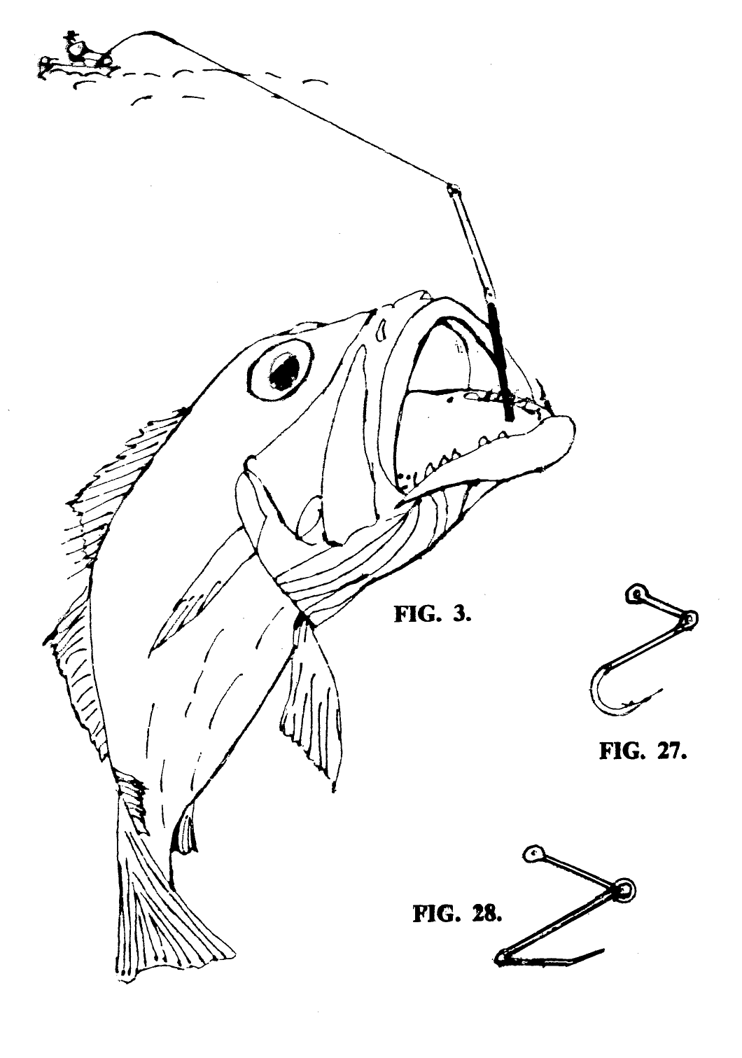

The myth of “hooking” the fish is perpetuated by massive overwhelming advertising designed to sell high price artificial bait lures. This advertising acts to teach the fishermen that fish follow the lure and eat it “tail first”. This is totally against the natural instincts of all fish. Mostly it is only “chopper” tailor and sharks, which bite out the stomach first to disable the prey. Most other fish eat to survive and eat head first. The artificial lure industry evolved and grew by using standard “J” fishing hooks without designing a hook to suit the facts. As shown in FIG. 5, a lead ball is added near the “J” shape hook eye for added weight, and a plastic fish fitted with its' mouth against that towing eye as shown in FIG. 6.
The new design “Z” shape hook is distinguished from all prior art as the sharpened hook point faces away from the fisherman in the opposite direction to all “J” shape prior art.
The new design “Z” shape hook is also distinguished from all prior art because it changes shape once the fish is impaled on the sharp hook point.

The “Z” shape hook has an extended shank length bent to an additional nominal forty-five degree angle. This angle is designed weak to straighten out to become a straight long shank. The “Z” shape hook changes shape once-only to become a “J” shape to haul that fish back to that fisherman.

This shape change will occur only when the hook point impales a fish. The added tensile force of a struggling fish pulling against the fishing line snap-bends the low-bending strength of the nominal forty-five degree bend. The two shank arms straighten into one long straight shank. The “Z” shape becomes a “J” shape to haul the fish back to the fisherman. Shape change may be a once-only change and the apex angle may snap off if again bent to the original angle.

The new “Z” shape hooks allow the fisherman to present his baited hook to this wild untamed marine fish in the most natural manner as the fishing line is towing this bait-fish from above and behind the bait-fish head. There is no fishing line obstruction. The nominal forty-five degree angle in the “Z” hook shank is located near the top front of the dorsal fin of the bait-fish. Fish have evolved a streamlined shape. The front top of the dorsal fin is a natural point of balance to tow from when the fishing line angles upwards and forward to the fisherman.

The bait-fish head is open and clear of all obstruction. The attacking fish takes in the hook point as it is given a “free bite” of the bait-fish head.

The attacking fish acting instinctively to eat this easy meal, will attack the head at lightning fast speed opening it's mouth in the last split second of the attack. The mouth opens to swallow the bait-fish whole as the fish moves forward. The bait-fish head is engulfed into the inside of the attack fish mouth. The top lip of the attacking fish is then trapped in “V” formed by the nominal forty-five degree angle of the “Z” shape hook. The attacking fish cannot continue it's forward momentum and swallow the bait-fish. Most fish have a pointed mouth with lips forward of teeth and forward of the eyes to allow them better access to food in confined places. The top of the head rises upwards and backwards from these forward lips and mouth. The top of most fish therefore forms roughly a “V” shape which slips easily into the included “V” angle between the fish hook eye and the nominal forty-five degree angle formed in the extended shank. The attacking fish head slips in under the fish hook eye and fishing line. The first thing the attacking fish feels with it's upper lip is the solid steel arm between the eye and the nominal forty-five degree angle in the shank of the hook. This angle apex is located at the top and front of the bait-fish dorsal fin which is well behind it's head.

The natural eating instinct of the attacking fish is to detect if this is “real food”. The fish has no hands to feel, it's sight instinct is not in play and it is left only with the sensitivity of it's mouth to detect if something is not right. The fish “mouths” the food object to detect this. The bottom jaw closes slightly to fit the fish object and the lips and inside of it's mouth “feel” the food to sense and detect any problem. The attacking fish also sucks in a great quantity of water causing a great vacuum to form to wash the bait-fish down it's throat in one huge swallowing action. The bait-fish and hook are both sucked into this open mouth all moving in one direction down the throat to the stomach.

The second fundamental advantage of the “Z” hook is the deliberate positioning of the sharpened hook point and barb. At this most critical moment of eating this hook point is positioned inside the attacking fish mouth, touching the muscle membrane of the lower jaw behind the front row of teeth, This needle sharp hook point faces outwards as this fish mouths the bait-fish. The slightest movement will impale this hook point into the most vulnerable part of this fish mouth. This “Z” hook point is designed to target this vulnerable spot which cannot be protected in this moment of eating. The whole of the upper mouth is protecting the brain with hard bone and a thin skin of muscle, which resists and prevents hook penetration. A hook point angled correctly will penetrate the muscle and sinew of the lower jaw and hold against the bone supporting jaw and teeth. The “Z” hook achieves this deliberate target.

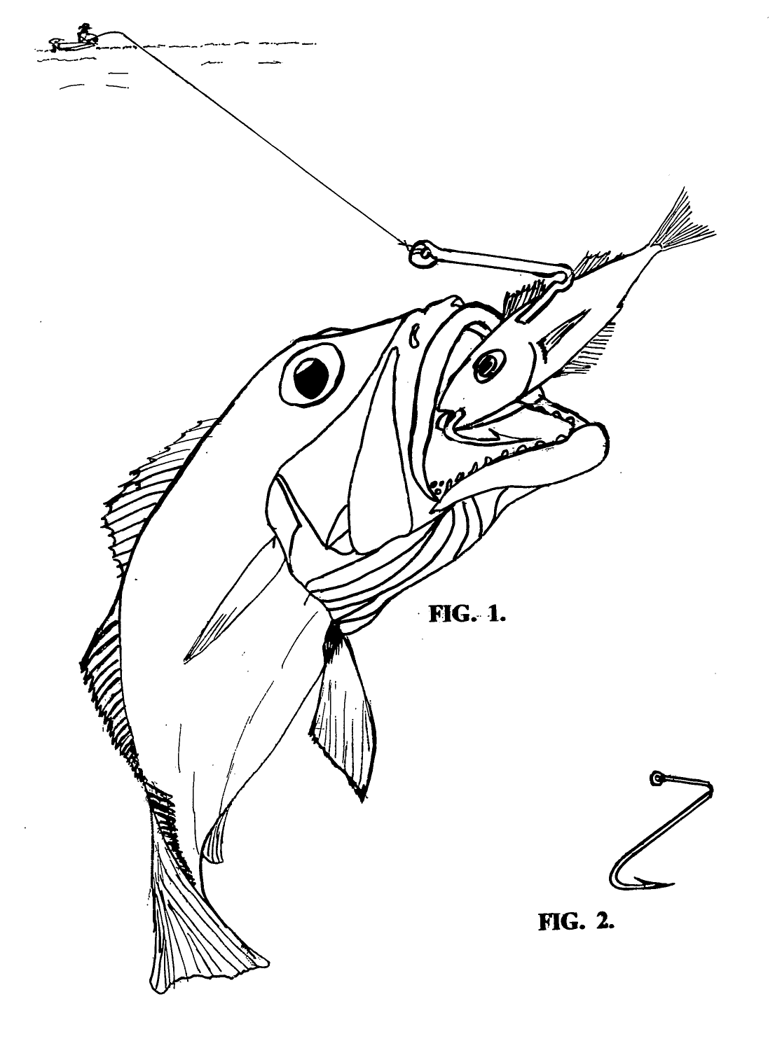

FIG. 1. illustrates this moment of attack when the attacking fish attempts to swallow the baited “Z” shape fish hook. The attacking fish is moving forward at great speed to swallow the bait-fish head first, continuing it's forward momentum to completely swallow the bait-fish and continue swimming. FIG. 2. illustrates same “Z” shape fish hook design, without the added bait-fish. FIG. 1. illustrates the “Z” shape hook solution to the fundamental flaws of the traditional “J” shape fish hooks illustrated in FIG. 6. The contrast of the two fish hook designs is compared at the moment chosen by the attacking fish to eat a “live fish” by it's chosen instinctive method of “head” first. The bait fish is threaded onto the “Z” shape hook by first impaling the bait-fish just under the skin above the backbone at the front of the dorsal fin sliding the hook up to the nominal forty-five degree bend and then threading the hook point through the bait-fish mouth and through the soft lower jaw membrane to appear below the bait-fish jaw with the hook point exposed and pointing backwards towards the bait-fish tail. This may be varied by pinning both top and bottom lips together at the hook bend while the hook point always points towards the bait-fish tail. Design must allow for other factors.
The bit covering up and disguising the bulk of the hook may be alive or dead. It may be an imitation plastic fish. To appear natural, moving, and “alive” it must comply with basic nature. It must swim forward in a natural manner. The “Z” shape hook achieves this by altering the towing point from the front of the mouth to the top of the dorsal fin. The fishing line slopes upward and towards the fisherman. It is above and clear of the bait-fish head and does not obstruct the fish making it's head to head attack.
The baited “Z” hook is tied to the fishing line at the small circle eye. When pulled through the water by the fishing line this hook point faces away from the fisherman and the bait-fish swims forward towards the fisherman. The fishing line starts above the bait-fish head. The “Z” hook eye is located above the bait-fish head. The fishing line when pulled taut by the fisherman rises through the water at an angle upwards to the fisherman located anywhere above the water surface. Normally the fisherman will be some considerable distance away on the water surface in a boat or back on the riverbank or other dry land. This fishing line attached to the “Z” hook will mostly be above the hook and mostly taut. The nominal angle of the line will be about forty-five degrees upwards from the hook.

FIG. 1. illustrates the “Z” shape hook ready in the normal fish attack position which is the normal fish-eating attitude due to several factors.
1. Fish have evolved so they must swim forward. Fish do not swim backwards. Fish may adjust their forward movement to any angle up, down or sideways, and sometimes a one hundred and eighty degree turn twisting up, down or sideways as FIG. 1. and FIG. 6. illustrate.
2. Fish normally swim upright, the head and dorsal fins closer to the water surface and the stomach closer to the solid bottom of the lake or river or ocean floor. For this reason the fish being eaten is normally swimming forward unaware that it is about to be eaten, head and dorsal fin up and stomach nearer the bottom. The attacking fish has choice of position and attitude. Mostly both fish present the smallest visual target head on. Most fish have two eyes located on either side of their head commanding the widest view available of their environment. This view is predominantly sideways with the least view forward. This forward view is obtained by a sideways sweep of the head.
3. At any given moment the smallest most vulnerable view of the attacking fish moving at an incredible speed to swallow, is head on.
4. A head on attack presents the least time for the bait-fish to react to avoid being eaten as the closing speed is increased by the forward speed of the is fish being eaten. Attack time is therefore compressed.
5. The head-first attack is so fast that reaction time, between sight of danger and muscle movement of the tail to avoid being eaten is only milliseconds, and so fast that the smaller fish is mostly eaten head first. Normally the fish is swallowed whole, defenseless, alive, and kicking it's tail on the way down. This is daily life. The larger fish simply swims on.

This head to head confrontation between fish is a speed event and is mostly conducted upright. The attacking fish varying it's direction slightly to capture the sideways or downward instinctive movement of the fish being eaten.

The “Z” hook is designed so the hook point always is located below the bait-fish mouth and therefore always targets the vulnerable inside lower mouth of the attacking fish. This sharpened hook point is mostly nearer the solid bottom and furthest from the water surface because the fisherman mostly pulls on the fishing line. This action pulls the eye closer to the surface. The streamlined design shape of the bait-fish tends to keep it's forward moving attitude upright dorsal fin uppermost. The “Z” hook rides eye uppermost and the hook point is the lowest point most of the time, in normal use. This hook point is positioned ready for ah attacking fish at all times.

When the attacking fish with it's forward movement has the bait-fish head in it's mouth and is mouthing it to detect a problem it cannot immediately reverse it's forward momentum. Nature has designed fish to reject an object in it's mouth which it detects as unwanted. In the instant the attacking fish detects it cannot go forward as the nominal forty-five degree angle of the “Z” hook presents an unavoidable obstruction the hook point is poised ready to impale the lower jaw membrane. The forward momentum of the attacking fish hitting the top of the dorsal fin of the bait-fish causes the fishing line to tension and resist that forward momentum. The attacking fish may feel the hook point. It may start to move away from that hook point. The hook point may be levered into the lower jaw membrane by the forward momentum of the attack fish causing a tension force on the fishing line. The hook point is levered forward in a short forward and downward arc. This hook point begins to impale the softer sinew and muscle of the lower jaw. Tensile force on the shank changes a “Z” shape to a “J” shape.

The attacking fish makes decision to reject the bait-fish it is attacking. The hook point is in or partly into the flesh. The increased tension on the taut fishing line alerts the fisherman. He reacts and adds some tension to the fishing line or he instinctively jerks the line to “hook” the fish. He is way too late, it's all over long before he detects a “bite”. That fish is impaled in the lower jaw. The attacking fish reacts to the hurt of the needle point and blows and spits out the contents of it's mouth in an explosive reaction designed in nature to save this fish from danger. As this expelling action is occurring the fish maximizes it's momentum and changes it's direction away from the danger. It feels the hook point penetration and feels the tension of the fishing line. The rejection expelling action of the fish acts on the bait-fish causing it to move outwards. The “Z” hook point has already started to penetrate the inside mouth flesh. The expelling action on the bait-fish only serves to drive home the needle sharp hook point deeper into mouth flesh assisting to secure the fish.

The forward momentum of the attacking fish is now diverted away from danger and increased by an inherent survival mechanism providing maximum power and momentum. At this point the fishing line may break. Modern braided line has very little give and fishermen use a short length of monofilament line between main line and fish hook, even a doubled short length of monofilament as this type of line may stretch twenty percent in length. This monofilament line is used as a shock-absorber of the accelerated fish momentum.

As the fish attempts escape from this impaled needle point fish hook, the barb stops the needle point being extracted. The fish momentum exceeds the design bending force of the nominal forty-five degree angle in the shank of the “Z” hook and the steel bend fails bending the shank straight. The “Z” hook changes shape to become a “J” shape and as the fish fights against the fishing line tension the hook point tends to be driven further into the lower jaw muscle and sinew. It does not tend to release the fish from the hook. The fish is hauled back to the fisherman who claims that he caught this fish.

“J” shape hooks used the way the industry advertising indicates are expected to re-educate fish to eat against their natural instincts “tail first” and head last. This type of lead weighted “J” shape hook in FIG. 5. is fitted with a plastic fish, illustrated in FIG. 6. It should be noted that if the fish did push past a slack fishing line to eat this lure the fishing hook would enter it's mouth eye first then hook point and then the bend. A pull on that fishing line would cause the hook to roll out against the bend. This would pull the hook point in a backward arc without a chance of impaling the fish mouth. Fishermen often speak of catching a fish “on the drop”, which means when the line is slack and the fisherman waits out of control for the lead weight to pull his line back a bit. This places the lead ball and eye plunging towards the bottom dragging the line after it. A head first bite is then possible without line obstruction, however the hook is swallowed the wrong way round. Little chance of impaling the fish mouth, more luck than skill.

A “J” shape hook lightly pinning a live bait fish at the dorsal fin is carried forward dragging the fishing line after it. The hook point faces the bait-fish tail and this hook will go down the attacking fish throat bend first then hook point and lastly the eye and the fishing line as the bait-fish is eaten naturally head first. This is why live fish bait is so deadly allowing the “J” shape hook to work correctly as designed. Modern fishermen do not have the time to catch their own live bait and so settle for second and third best dead bait or artificial bait. Dead and artificial baits require a hook designed for the purpose.

“Z” shape hooks are designed for any live bait and for dead and artificial baits trying to appear as “live fish”. They have a bonus benefit from this shape also as the hook point in use and when pulled by the fishing line will not impale anything, the bend supporting the hook point will slide off and around any object. This will save fishermen a lot of money previously spent on lost hooks and tackle.

It is anticipated that many designs of fish hooks will now be developed using all or part of the knowledge revealed in this patent. The “Z” shape may be varied to an “S” shape or any combination of a “Z” and or an “S” shape.

The “Z” hook described may be manufactured in mass production volumes using existing wire bending hook making machinery with only minimal additional wire cost. The shank length only is increased. This shank length is bent in the same plane as the bend in the opposed direction creating a second shank arm and an included nominal angle of forty-five degrees, a little more or a little less. The bending strength of the apex of this included angle is deliberately made weak while retaining the same tensile strength as the rest of the wire hook. This apex may be flattened as illustrated in FIG. 22. to achieve an engineered weak bending strength in one plane only. A round wire may become oval by a hammer blow on an anvil. It may also be heat treated in manufacture to achieve very low bending strength. This joint may be created from two wire arms joined with a pivot, by simple bolt and nut or an axle riveted both ends. It may also be joined or spring loaded or with a wire circle loop formed from a separate wire or using the same wire bent and looped to 360 degrees plus 135 degrees more or less.

It is anticipated that a form of this “Z” shape hook may be created with a single wire shank having an eye formed at each end being mounted to the eye of a standard “J” hook with a pivot axle of some sort, ball joint, bolt and nut, rivet axle with or without a weak adhesive or similar to bend or loosen on tension pull.

The length of the short shank between the eye and the included nominal forty-five degree angle in the extended shank will normally be less than the length of the shank between bend and that nominal forty-five degree angle apex. This is to ensure that the bend supporting the sharpened hook point is always forward of a vertical line through that angle apex. The fisherman will then attach the live or dead or artificial bait-fish correctly, and its' head which will therefore always be forward of the fishing line attachment eye. This ensures the fishing line will be above and clear of the bait-fish head while underwater in use.

Fishing is attempting to have a hook point in a fish mouth to enable the fisherman a chance to hook it and bring it back to him. This has always been the goal, to get the fish hook into the fish mouth. Most technological development has been aimed at attracting the fish to the fish hook using “food” and color and scent and or vibrations within the fishing lure. No fish hook by itself can do this, as a bent piece of wire by itself is foreign to this natural environment. Food is the only thing a fish normally takes into its' mouth with marine creatures or plant-life.

A fish hook in the fish mouth has always been enough. Anywhere in the mouth or stomach as long as it impales the fish as the fishing line is pulled. The fact that the roof of a fish mouth is protected by bone from being impaled did not matter. Not until the development of the circle hook had any section of the fish mouth been targeted. The circle hook only becomes lodged as the hook is slowly dragged out of the fish mouth, lodging in the jaw hinge. Any attempt to “hook” the fish with a circle hook will lose that fish.

The new “Z” hook effectively targets the inside lower jaw of a fish of any species. This is achieved by always having the hook point under the bait head, alive or dead and artificial fish or marine creature. It is only by changing the bait towing point from front of the mouth to above the head and just in front of the dorsal fin that this bait head is unobstructed

Locating the hook point to face the bait or bait-fish tail ensures the hook bend enters the targeted fish mouth first and that the hook point faces out of this targeted fish mouth. This positioning of the hook point by adding the bait or bait-fish to the fishing hook ensures the hook point has maximum chance to impale that targeted fish. Targeting the most vulnerable part of its' mouth, at the only part where there is no bone to repel and prevent penetration of that hook point is a deliberate part of this “Z” hook design.

The bait may be weighted with lead or the hook may have some small mass added near the bend or be concentric molded with the wire bend as its core though this is not essential to the hook operation. The hook will have a natural ability to ride vertical in use, as the towing eye is the uppermost part when the fishing line is pulled. It may help to have a small floatation element or bead added near the towing point to assist it to stay vertical, though this is not essential to the hook operation. Generally by common sense, the fisherman adding the bait-fish to the hook will add it to face towards him as he pulls the fishing line. The natural fish shape and mass and density of that bait will ensure it swims forward in an upright manner be it alive or dead. This natural streamlining will ensure the hook point is the lowest part and ready for a fish attack at all times.

This hook point placement at the lowest part of the bait has always been prevented as the “J” hooks always have this point ready to impale anything. Consequently it did impale any snag or solid object under that water causing that hook to be lost long before it could catch a fish. Hook point placement on the “J” hooks evolved to be above the bait to prevent or at least minimize snagging and loss of hooks. This is still a massive problem for fishermen. With “Z” hooks, snagging the hook point will become such a rare event it will never be a problem again. The bend supporting the hook point will normally slide over and prevent the hook point from contact with any solid object.

As the hook must have a bait attached for the hook to ever be taken into the fish mouth the hook point will never come under tension from the fishing line in normal presentation mode. Only when the hook point is driven into the fish flesh, creating a solid mass at one end of the hook and a resisting fishing line held by the fisherman at the other, will tensile force be created. This tensile force will overcome the pre-calculated strength of the apex angle in the extended shank. Only under these conditions will the forces cause this “Z” shape fishing hook to change shape to a “J” shape. This angle apex will be engineered to fail under specific tensile force. It may be calculated to fail totally and snap-bend to become one long extended shank between the eye and the bend. It may be engineered to resist slightly and act to absorb some of the tensile force as a shock-absorber. It may be manufactured with a very small loop circle as shown in FIG. 27, at the apex of the angle in that extended shaft so that the tensile forces exerted on the fishing line by that fish may move the angle wider and wider in several shock absorbing stretches of that “Z” hook assisting the fisherman to slow down this wild impaled fish in it's final attempt to free itself. Alternatively a small circle loop may be created outside the nominal forty-five degree apex in the shank as shown in FIG. 28. All “Z” shape hooks may be made in one two dimensional plane or may stretch with-in three dimensions. The hook point in the inside lower jaw may be driven through this sinew and muscle and the bend may become caught by the jaw-bone holding the teeth in the front of the fish lower jaw. “Z” fishing hooks will hold fish cleanly in the most humane manner as the hook point in this targeted area of the fish mouth will do the least damage.

An attacking fish can not normally swallow the “Z” shape fishing hook. Its' top lip will normally be trapped in the “V” formed above the bait-fish head by the fishing line. This prevents the hook from being swallowed. If by mistake the hook is swallowed, it is likely to be expelled by the fish in reaction and slip harmlessly from the fish mouth without becoming entangled. It would then be normally used to catch a fish without change. The normal “Z” fish hook makes a one-only shape change. Only a second re-set pivot angle version is capable of re-use.

Nature has provided fish with incredible acceleration. Fish move so fast that the water moves and swirls around the millisecond eating action. The fisherman has no control of the actual fish-eating action. It is a speed thing totally out of his control. He cannot react in the millisecond of the fish-eating action. The hook point must be in position before the fish-eating event. There is no time to re-position that hook point by any means. The hook point must do its' job without help from the fisherman, or his jerk of the fishing line.

As it has always been such a hard job to catch a fish, the industry left the objective to get a fish hook in the fish mouth behind as it developed. To keep fishermen interested in fishing they have developed the modern lure with two or three swinging hook devices. Each device known as a treble hook, has three hook points on each hook device. These two or three treble hooks provide either six or nine sharp hook points swimming free under an imitation swimming fish towed from the front with a fishing line. Advertising encourages fishermen to view these lures as “one hook” to catch “one fish” in belief that the fish will swim up behind this lure and swallow it from behind “tail first”. This of course is not true.

In reality the fish makes a natural attempt to eat this attractive pretty fish naturally “head first”. The attacking fish first hits the fishing line which it could not “see” as huge technical efforts have been made to have this line transparent at this point. The attacking fish lips push this fishing line aside slightly causing a glancing blow as the fish misses the lure head. As the lure slides forward against the attacking fish body it runs the gauntlet of these six or nine hook points swinging under this fishing lure. This is a minefield of hook points designed to snare any part of that fish which is close. The fish caught by one or more of these hook points is “foul hooked”, in the flesh, in the fins, in the tail, or in the side of the mouth or in the eye. This used to be called “jagging” and has always been considered un-sportsman-like; “jagging” is normally regarded as illegal by authorities in some countries.

The latest deep-water jigs now use a steel “bait fish” without hooks at the tail. They use a swinging circle hook on a short lanyard near a prominent “fish eye” in the obvious head. This hook point is to make random contact in the fish mouth. The “Z” shape novel hook rides point down facing away from the fisherman to specifically attack the vulnerable flesh inside of the mouth and lower jaw of the attacking fish. This attack target point is specifically designed to avoid hook point contact with the hard bone protected roof of the fish mouth. Nature protects the fish brain above the fish mouth with solid bone making it almost impossible to impale with a fish hook point swinging anywhere in the fish mouth.

The modern lure industry promotes constantly jigging the fishing line and lure. The effect is to hopefully have the hook point hit something it can impale on the way out of a fish mouth. If not it may impale any part of the skin of any fish. Anything is better than nothing. The fact is that the hook point of these plastic lures generally is facing down the fish mouth and means it has to turn backwards as the “J” shape hook-bend turns backwards pulled by the fishing line. A very random chance of impaling a fish mouth. A lottery chance of hooking a fish.

This novel “Z” shape design traps the top lip of the attacking fish in the nominal forty-five degree angle. The fish immediately senses the obstruction and reacts. It's forward momentum prevents a backwards retreat. The “Z” shape hook point is inside it's mouth. It may have been mouthing the food. The most likely natural reaction is to spit the food out. The hook point poised on the vulnerable lower jaw flesh has the most chance to impale this softer flesh and muscle as the fish attempts to spit it out. Chances of a solid “hook-up” are maximized.

“Z” shape fishing hooks Will in time make it easier to catch fish by changing the way “bait” is presented to fish, and this will improve the numbers of fish caught. Fishermen are completely out-matched by fish. For one fish to eat another living fish, which is alert, and avoiding being eaten, is quite a feat. Nature gave fish incredible acceleration, speed, and cunning.

I claim:

1. A fishing device formed from drawn steel wire into a nominal two dimensional “Z” shape having a towing eye for tying a fishing line at one end and the other end sharpened to a fine point with each end opposed one hundred and eighty degrees more or less to the other end.

2. A fishing device formed from drawn steel wire into a nominal two dimensional “S” shape having a towing eye for tying a fishing line at one end and the other end sharpened to a fine point with each end opposed one hundred and eighty degrees more or less to the other end.

3. A fishing device formed from drawn steel wire into a nominal two dimensional “Z” or an “S” shape or “G” shape or combination shape having a fishing line towing eye at one end and sharpened fine hook point opposed one hundred and eighty degrees more or less to the opposite end substantially as described with reference to the accompanying drawings.

4. A fishing device formed substantially as claims one and or two or three with the length of the towing eye arm nominally less in length to the diagonal arm with the top included angle apex formed at nominally forty-five degrees more or less. The sharp hook point end of the diagonal arm may form an open semi-circle bend between apex and point. The steel of the apex at the upper included angle joint is weakened with thinning or distorted and stamped or heat treated to snap-bend under tension force applied between each end of this fishing hook device and change the nominal “Z” hook shape to a “J” shape. Any hook designed to change shape for any purpose. Apex angle may or may not be later reset to an original angle.

5. Any fishing device formed from drawn steel wire into a nominal two dimensional “Z” or “S” shape or “G” shape or combination shape substantially as described in claims one to four inclusive with or without a stabilizing flotation tail and with or without added mass as small lead weight molded concentric about the lower wire diameter bend maintaining the device vertical in use.

6. Any fishing device formed from drawn steel wire into a nominal two dimensional “Z” or an “S” shape or combination shape substantially as described in claims one to five inclusive having a weak section to snap-bend under tension force between towing eye and sharpened point and change shape to a nominal long-shank “J” shape hook.

7. Any fishing device formed from drawn steel wire formed into a nominal two dimensional “Z” or an “S” shape or combination shape substantially as described in claims one to five inclusive having a captive axle pivot join to snap-turn under tension force between towing eye and sharpened point changing shape to a nominal long-shank “J” shape hook.

8. Any fishing device formed from drawn steel wire into a nominal two dimensional “Z” or an “S” shape or combination shape substantially as described in claims one to seven inclusive formed from many parts having one or more axle pivot join section held to turn under tension force between towing eye and sharpened point.

9. Any fishing device formed to change structural shape to become a nominal two-dimensional “J” shape only under applied tension force. Any fishing hook device designed to change shape underwater for a specific purpose.

10. Any formed steel or similar material wire fishing device presenting a single fixed sharpened hook point facing away from a fisherman pulling it with a fishing line. Any device acting to breach this claim with many hook points.

11. Any formed steel or similar material wire fishing device presenting its' only sharpened hook point facing away from a fisherman pulling the device with a fishing line and presenting a bend supporting that sharpened point located forward of a vertical line through the towing eye.

12. Any formed steel or similar material wire fishing device presenting a sharpened hook point facing away from a fisherman pulling it with a fishing line presenting a bend supporting that sharpened point located forward of a vertical line through the towing eye or locating the formed towing point above and behind the sharpened hook point.

13. Any formed steel or similar material wire fishing device presenting a sharp hook point facing away from a fisherman pulling it with a fishing line and presenting a bend supporting that sharpened point located forward of a vertical line through the towing eye and/or locating the towing eye above and behind the sharpened hook point formed to make a once only shape change under tension pull against the sharpened hook point and or weighted at the lower part for the device to remain vertical in use.

14. Any fishing hook device formed to make a once only structural shape change under specific sudden tension or specific stretching tension pull on a towing eye opposed one hundred and eighty degrees more or less to the other sharpened hook point end.

15. Any fishing hook with any weakened metal section or an adjustable movable joint held by friction or weak adhesive formed adjacent to the towing eye or of any fishing device with a turning once-only or reset-able angle joint capable of device shape change under any force or spring or release device or device adjustable as a re-useable hook.

16. Any fishing hook or device using an extended shank of the traditional “J” shape fishing hook to relocate the towing eye behind the fishing hook bend supporting the sharpened hook point and or an adjustable or moveable axle pivot joint formed with an axle or captive ball joint or swivel and or using similar extended shank hook formed to relocate the towing eye and or to face the sharpened hook point away and opposed to the towing direction of the towing eye.

17. Any fishing hook or device using an extended shank of any traditional “J” shape fishing hook formed to relocate the towing eye from towing at the front of the hook.

18. Any fishing hook or device using an extended wire or similar shank of any traditional “J” shape fishing hook formed to relocate the towing eye remote from towing at the front as a single or a twin or a triple or multiple hook unit. Any device towed by a single or multiple fishing line towing an outrigger arm or multiple outrigger arms pulling any combination of “J” or “Z” or “G” shape fishing hooks allowing any attached artificial bait or alive or dead marine bait to swim head first clear of that fishing line.

19. Any fishing hook or device substantially as described herein with reference to the accompanying drawings with a bend supporting any sharpened hook point weighted by some concentrated mass about or as part of the diameter of that wire bend by molded lead or by similar method to maintain that bend nominally vertical in use with or without a floatation device or stabilizing tail above and adjacent to the towing eye.

20. Any fishing hook device substantially as herein described with reference to the accompanying drawings.
